(19) United States
(12) Patent Application Publication
(10) Pub. No.: US 2014/0285306 A1
(43) Pub. Date: Sep. 25, 2014

(54) ELECTRONIC COMPONENT

(71) Applicant: MURATA MANUFACTURING CO., LTD., Kyoto (JP)

(72) Inventor: Soitsu SASAKI, Kyoto (JP)

(73) Assignee: MURATA MANUFACTURING CO., LTD., Kyoto (JP)

(21) Appl. No.: 14/296,239

(22) Filed: Jun. 4, 2014

Related U.S. Application Data
(63) Continuation of application No. PCT/JP2012/078369, filed on Nov. 1, 2012.

(30) Foreign Application Priority Data
Jan. 6, 2012 (JP) 2012-001405

(51) Int. Cl. H01F 27/28

(52) U.S. Cl. CPC H01F 27/2804; H01F 2027/2809
USPC 336/200

(57) ABSTRACT

In an electronic component, a multilayer body is formed by a plurality of stacked insulator layers. A coil includes at least one coil conductor layer provided on at least one of the insulator layers. External electrodes are embedded in a lateral surface of the multilayer body which is formed by a series of continuous perimeter edges of the plurality of insulator layers, and includes a plurality of stacked external conductor layers provided on the plurality of insulator layers. The external electrodes have different shapes. The external conductor layers and the first coil conductor, which are provided on the same insulator layer, are simultaneously formed by photolithography or printing.

### CROSS REFERENCE TO RELATED APPLICATIONS

This application claims benefit of priority to Japanese Patent Application No. 2012-001405 filed on Jan. 6, 2012, and to International Patent Application No. PCT/JP2012/078369 filed on Nov. 1, 2012, the entire content of each of which is incorporated herein by reference.

### TECHNICAL FIELD

1. Field of the Disclosure

The present disclosure relates to an electronic component and more specifically relates to an electronic component which includes a coil.

2. BACKGROUND

An example of known conventional disclosures relating to electronic components is an inductor described in WO 2007/080680. The inductor is formed by providing a coil in a multilayer body which is formed by stacking insulator layers. An external electrode is embedded in a lateral surface of the multilayer body and is formed by photolithography simultaneously with formation of the coil. In the inductor described in WO 2007/080680, the external electrode and the coil are formed in the same step. Therefore, the positional relationship between the external electrode and the coil is unlikely to deviate from a predetermined positional relationship.

In a field to which the inductor described in WO 2007/080680 relates, a structure which can be configured to have arbitrary electric characteristics has been demanded.

### SUMMARY

### Problems to be Solved by the Disclosure

In view of the above, an object of the present disclosure is to provide an electronic component in which the positional relationship between the external electrode and the coil is unlikely to deviate from a predetermined positional relationship while the electronic component has a structure which can be configured to have arbitrary electric characteristics.

### Solution to Problems

An electronic component according to the present disclosure includes: a multilayer body having a shape of a rectangular parallelepiped, and including a plurality of stacked insulator layers; a first coil including at least one first coil conductor layer provided on at least one of the plurality of the insulator layers; and first and second external electrodes embedded in a lateral surface of the multilayer body which is formed by a series of continuous perimeter edges of the plurality of insulator layers, the first and second external electrodes including a plurality of stacked external conductor layers, the plurality of stacked external conductor layers being provided to the plurality of insulator layers, wherein the first external electrode and the second external electrode have different shapes, and the external conductor layers and the first coil conductor, which are provided to the same insulator layer, are simultaneously formed by photolithography or printing.

### BRIEF DESCRIPTION OF THE DRAWINGS

FIG. 1 is a perspective view of the exterior of an electronic component according to one embodiment.

FIG. 2 is an exploded perspective view of the electronic component of FIG. 1.

FIGS. 3A to 3D are first to fourth plan views of manufacture of the electronic component, respectively.

FIGS. 4A to 4D are fifth to eighth plan views in manufacture of the electronic component, respectively.

FIGS. 5A to 5D are ninth to twelfth plan views in manufacture of the electronic component, respectively.

FIGS. 6A to 6D are thirteenth to sixteenth plan views in manufacture of the electronic component, respectively.

FIG. 7 is an equivalent circuit diagram of the electronic component.

FIG. 8 is a graph showing the relationship between the frequency and the attenuation of the output signal relative to the input signal in the electronic component.

FIG. 9 is an exploded perspective view of an electronic component according to the first variation.

FIG. 10 is an exploded perspective view of an electronic component according to the second variation.

FIG. 11 is a perspective view of the exterior of an electronic component according to the third variation.

### DETAILED DESCRIPTION

Hereinafter, an electronic component according to an embodiment of the present disclosure is described.

Configuration of Electronic component

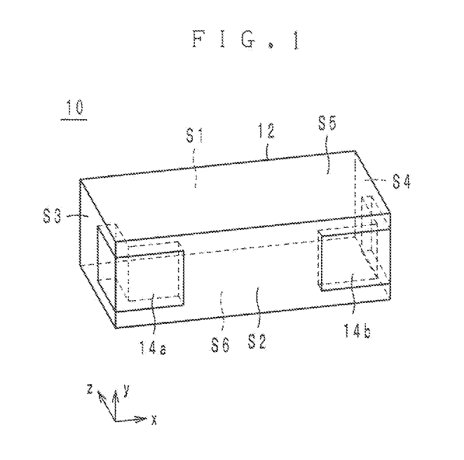

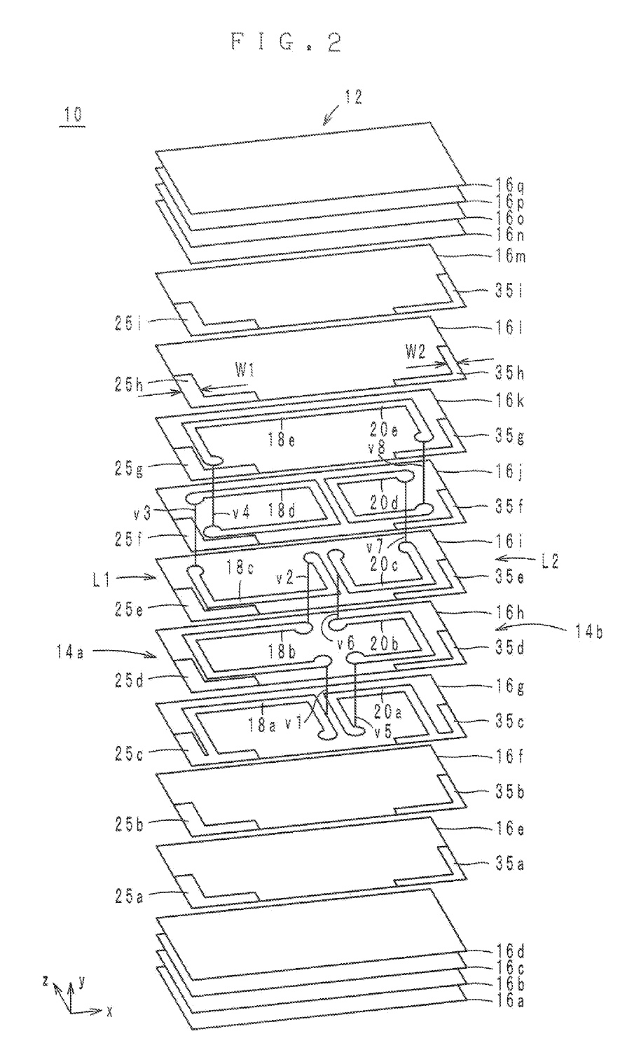

Hereinafter, the configuration of an electronic component according to one embodiment is described with reference to the drawings. FIG. 1 is a perspective view of the exterior of an electronic component 10 according to one embodiment. FIG. 2 is an exploded perspective view of the electronic component 10 of FIG. 1. In the following description, the layer-stacking direction of the electronic component 10 is defined as the “y-axis direction”. When viewed in plan from the y-axis direction, a direction in which the long side of the electronic component 10 is extending is defined as the “x-axis direction”, and a direction in which the short side of the electronic component 10 is extending is defined as the “z-axis direction”.

As shown in FIG. 1 and FIG. 2, the electronic component 10 includes a multilayer body 12, external electrodes 14 (14a, 14b), and coils L1, L2 (not shown in FIG. 1).

The multilayer body 12 is formed by a plurality of insulator layers 16 (16a to 16q) which are stacked so as to be arranged in this order from the negative direction side to the positive direction side of the y-axis direction as shown in FIG. 2. The multilayer body 12 has a shape of a rectangular parallelepiped. Thus, the multilayer body 12 has lateral surfaces S1 to S4, an upper surface S5, and a lower surface S6. The lateral surface S1 is a surface of the multilayer body 12 which is on the positive direction side of the z-axis direction. The lateral surface S2 is a surface of the multilayer body 12 which is on the negative direction side of the z-axis direction. When the electronic component 10 is mounted to a circuit board, the lateral surface S2 serves as a mounting surface which is to face the circuit board. The lateral surface S1 is formed by a series of continuous long sides (i.e., perimeter edges) of the insulator layers 16 which are on the positive direction side of the z-axis direction. The lateral surface S2 is formed by a series of continuous long sides (i.e., perimeter edges) of the insulator layers 16 which are on the negative direction side of the z-axis direction. The lateral surface S3 is a surface of the multilayer body 12 which is on the negative direction side of the x-axis direction. The lateral surface S4 is a surface of the multilayer body 12 which is on the positive direction side of the x-axis direction. The lateral surface S3 is formed by a series of continuous short sides (i.e., perimeter edges) of the insulator layers 16 which are on the negative direction side of the x-axis direction. The lateral surface S4 is formed by a series of continuous short sides (i.e., perimeter edges) of the insulator layers 16 which are on the positive direction side of the x-axis direction. The lateral surfaces S3, S4 are adjacent to the lateral surface S2. The upper surface S5 is a surface of the multilayer body 12 which is on the positive direction side of the y-axis direction. The lower surface S6 is a surface of the multilayer body 12 which is on the negative direction side of the y-axis direction.

The insulator layers 16 have a rectangular shape as shown in FIG. 2 and are made of an insulating material whose main component is borosilicate glass, for example. In the following description, a surface of the insulator layers 16 which is on the positive direction side of the y-axis direction is referred to as “front surface”, and a surface of the insulator layers 16 which is on the negative direction side of the y-axis direction is referred to as “rear surface”.

The coil L1 is formed by coil conductor layers 18 (18a to 18e) and via hole conductors v1 to v4. The coil L1 has such a helical shape that it leads from the negative direction side to the positive direction side of the y-axis direction while circling around clockwise when viewed in plan from the positive direction side of the y-axis direction. The coil conductor layers 18a to 18e are provided on the front surfaces of the insulator layers 16g to 16k and have a shape of a rectangular annulus from which one side is cut away. The coil conductor layers 18a to 18d have ¾ turn, and the coil conductor layer 18e has ½ turn. The coil conductor layers 18 are made of, for example, an electrically-conductive material whose main component is Ag. In the following description, an end of the coil conductor layer 18 which is on the upstream side when viewed in a clockwise direction is referred to as “upstream end”, and the other end of the coil conductor layer 18 which is on the downstream side when viewed in a clockwise direction is referred to as “downstream end”.

The via hole conductors v1 to v4 penetrate through the insulator layers 16h to 16k, respectively, in the y-axis direction. The via hole conductors v1 to v4 are made of, for example, an electrically-conductive material whose main component is Ag. The via hole conductor v1 connects the downstream end of the coil conductor layer 18a to the upstream end of the coil conductor layer 18b. The via hole conductor v2 connects the downstream end of the coil conductor layer 18b to the upstream end of the coil conductor layer 18c. The via hole conductor v3 connects the downstream end of the coil conductor layer 18c to the upstream end of the coil conductor layer 18d. The via hole conductor v4 connects the downstream end of the coil conductor layer 18d to the upstream end of the coil conductor layer 18e.

The coil L2 is formed by coil conductor layers 20 (20a to 20e) and via hole conductors v5 to v8. The coil L2 has such a helical shape that it leads from the negative direction side to the positive direction side of the y-axis direction while circling around anticlockwise when viewed in plan from the positive direction side of the y-axis direction. The coil conductor layers 20a to 20e are provided on the front surfaces of the insulator layers 16g to 16k and have a shape of a rectangular annulus from which one side is cut away. The coil conductor layers 20a to 20d have ¾ turn, and the coil conductor layer 20e has ½ turn. The coil conductor layers 20 are made of, for example, an electrically-conductive material whose main component is Ag. In the following description, an end of the coil conductor layer 20 which is on the upstream side when viewed in an anticlockwise direction is referred to as “upstream end”, and the other end of the coil conductor layer 20 which is on the downstream side when viewed in an anticlockwise direction is referred to as “downstream end”.

The via hole conductors v5 to v8 penetrate through the insulator layers 16h to 16k, respectively, in the y-axis direction. The via hole conductors v5 to v8 are made of, for example, an electrically-conductive material whose main component is Ag. The via hole conductor v5 connects the downstream end of the coil conductor layer 20a to the upstream end of the coil conductor layer 20b. The via hole conductor v6 connects the downstream end of the coil conductor layer 20b to the upstream end of the coil conductor layer 20c. The via hole conductor v7 connects the downstream end of the coil conductor layer 20c to the upstream end of the coil conductor layer 20d. The via hole conductor v8 connects the downstream end of the coil conductor layer 20d to the upstream end of the coil conductor layer 20e.

The downstream end of the coil conductor layer 18e and the downstream end of the coil conductor layer 20e are connected to each other. Thus, the coils L1, L2 are connected in series.

As shown in FIG. 1, the external electrode 14a is embedded in the lateral surfaces S2, S3 of the multilayer body 12 which are formed by a series of continuous perimeter edges of the insulator layers 16a to 16q. A portion of the external electrode 14a which is exposed to the outside of the multilayer body 12 extends over the lateral surfaces S2, S3. Thus, the external electrode 14a is L-shaped when viewed in plan from the y-axis direction. As shown in FIG. 2, the external electrode 14a is formed by stacked external conductor layers 25 (25a to 25i).

The external conductor layers 25 (25a to 25i) are stacked as shown in FIG. 2 so as to penetrate through the insulator layers 16e to 16m in the y-axis direction and are electrically coupled together. When viewed in plan from the y-axis direction, the external conductor layers 25a to 25i are L-shaped and are in contact with the short sides of the insulator layers 16e to 16m which are on the negative direction side of the x-axis direction and with the long sides of the insulator layers 16e to 16m which are on the negative direction side of the z-axis direction. The external conductor layer 25c is connected to the upstream end of the coil conductor layer 18a.

As shown in FIG. 1, the external electrode 14b is embedded in the lateral surfaces S2, S4 of the multilayer body 12 which are formed by a series of continuous perimeter edges of the insulator layers 16a to 16q. A portion of the external electrode 14b which is exposed to the outside of the multilayer body 12 extends over the lateral surfaces S2, S4. Thus, the external electrode 14b is L-shaped when viewed in plan from the y-axis direction. As shown in FIG. 2, the external electrode 14b is formed by stacked external conductor layers 35 (35a to 35i).

The external conductor layers 35 (35a to 35i) are stacked as shown in FIG. 2 so as to penetrate through the insulator layers 16e to 16m in the y-axis direction and are electrically coupled together. When viewed in plan from the y-axis direction, the external conductor layers 35a to 35i are L-shaped and are in contact with the short sides of the insulator layers 16e to 16m which are on the positive direction side of the x-axis direction and with the long sides of the insulator layers 16e to 16m which are on the negative direction side of the z-axis direction. The external conductor layer 35c is connected to the downstream end of the coil conductor layer 20a.

Portions of the external electrodes 14a, 14b which are exposed to the outside of the multilayer body 12 are plated with Sn and Ni for anticorrosion purposes.

On both sides of the external electrodes 14a, 14b in terms of the y-axis direction, the insulator layers 16a to 16d and 16n to 16q are stacked. As such, the external electrodes 14a, 14b are not exposed at the upper surface S5 and the lower surface S6.

Here, the external electrode 14a and the external electrode 14b have different shapes each other. In the present embodiment, the thickness of the external electrode 14a is different from the thickness of the external electrode 14b. Specifically, the line width W1 of the L-shaped external conductor layers 25 is greater than the line width W2 of the L-shaped external conductor layers 35. As such, the distance between the external electrode 14a and the coil L1 is smaller than the distance between the external electrode 14b and the coil L2.

The external conductor layers 25c to 25g and 35c to 35g, which are provided on the same insulator layers 16g to 16k on which the coil conductor layers 18a to 18e and 20a to 20e are provided, are formed by photolithography or printing simultaneously with formation of the coil conductor layers 18a to 18e and 20a to 20e. The simultaneous formation herein means that, in the case of photolithography, the coil conductor layers 18a to 18e and 20a to 20e and the external conductor layers 25c to 25g and 35c to 35g are exposed and developed using the same photomasks. In the case of printing, it means that the coil conductor layers 18a to 18e and 20a to 20e and the external conductor layers 25c to 25g and 35c to 35g are formed using the same screen plates.

### Method for Manufacturing Electronic Component

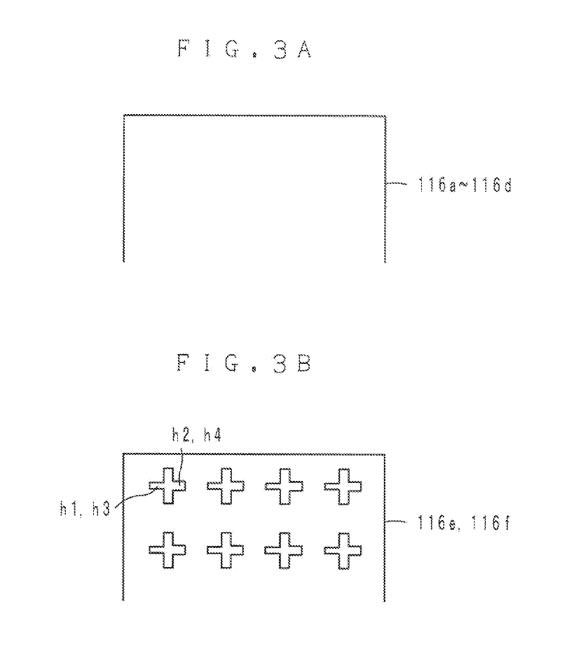

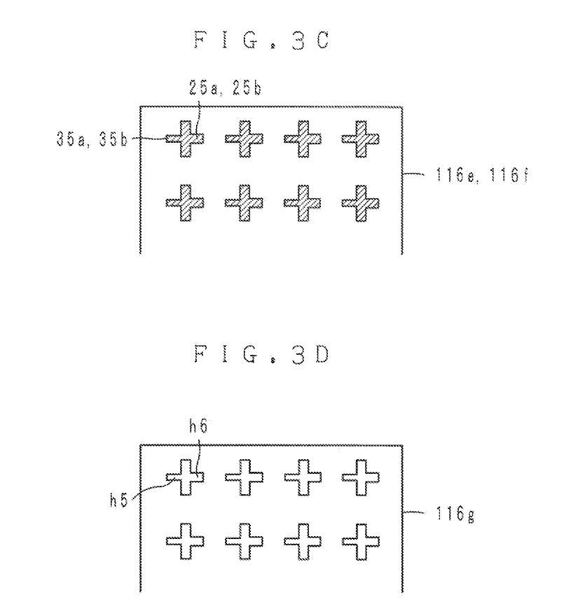

Hereinafter, a method for manufacturing the electronic component 10 according to the present embodiment is described with reference to the drawings. FIG. 3 through FIG. 6 are plan views of the electronic component 10 during manufacture.

Firstly, an insulating paste whose main component is borosilicate glass is repeatedly applied by screen printing to form insulating paste layers 116a to 116d as shown in FIG. 3A. The insulating paste layers 116a to 116d are paste layers which are to be the insulator layers 16a to 16d that are insulator layers for outer layers, which are arranged at outer positions than the coils L.

Then, as shown in FIG. 3B, an insulating paste layer 116e which has openings h1, h2 is formed by photolithography. Specifically, a photosensitive insulating paste is applied by screen printing to form an insulating paste layer 116e on the insulating paste layer 116d. Further, the insulating paste layers are irradiated with ultraviolet light or the like via a photomask and are developed using an alkaline solution or the like. The insulating paste layer 116e is a paste layer which is to be the insulator layer 16e. Each of the openings h1, h2 has a T-shape which is realized by joining two external conductor layers 35a, 25a. The openings h1, h2 are joined together to have a cruciform shape.

Then, as shown in FIG. 3C, external conductor layers 25a, 35a are formed by photolithography. Specifically, a photosensitive electrically-conductive paste whose metal main component is Ag is applied by screen printing to form an electrically-conductive paste layer on the insulating paste layer 116e. Further, the electrically-conductive paste layer is irradiated with ultraviolet light or the like via a photomask and is developed using an alkaline solution or the like. Thereby, the external conductor layers 35a, 25a are formed in the openings h1, h2.

Then, as shown in FIG. 3B, an insulating paste layer 116f which has openings h3, h4 is formed by photolithography. Specifically, a photosensitive insulating paste is applied by screen printing to form an insulating paste layer 116f on the insulating paste layer 116e. Further, the insulating paste layer is irradiated with ultraviolet light or the like via a photomask and is developed using an alkaline solution or the like. The insulating paste layer 116f is a paste layer which is to be the insulator layer 16f. Each of the openings h3, h4 has a T-shape which is realized by joining two external conductor layers 35b, 25b. The openings h3, h4 are joined together to have a cruciform shape.

Then, as shown in FIG. 3C, external conductor layers 25b, 35b are formed by photolithography. Specifically, a photosensitive electrically-conductive paste whose metal main component is Ag is applied by screen printing to form an electrically-conductive paste layer on the insulating paste layer 116f. Further, the electrically-conductive paste layer is irradiated with ultraviolet light or the like via a photomask and is developed using an alkaline solution or the like. Thereby, the external conductor layers 35b, 25b are formed in the openings h3, h4.

Then, as shown in FIG. 3D, an insulating paste layer 116g which has openings h5, h6 is formed by photolithography. Specifically, a photosensitive insulating paste is applied by screen printing to form an insulating paste layer 116g on the insulating paste layer 116f. Further, the insulating paste layer is irradiated with ultraviolet light or the like via a photomask and is developed using an alkaline solution or the like. The insulating paste layer 116g is a paste layer which is to be the insulator layer 16g. Each of the openings h5, h6 has a T-shape which is realized by joining two external conductor layers 35c, 25c. The openings h5, h6 are joined together to have a cruciform shape.

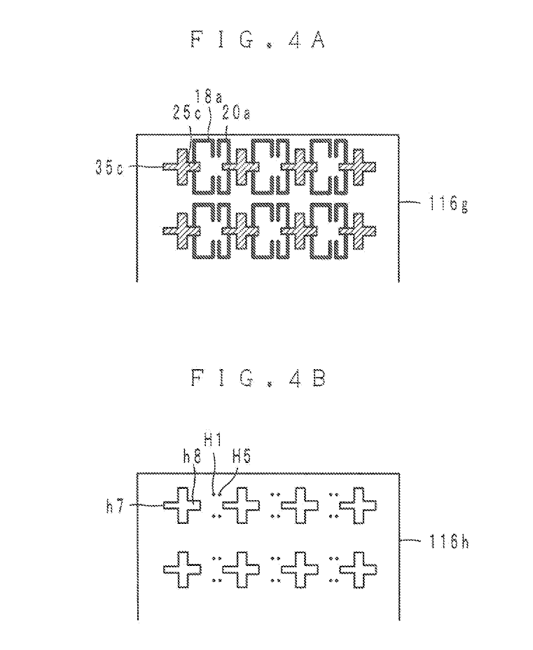

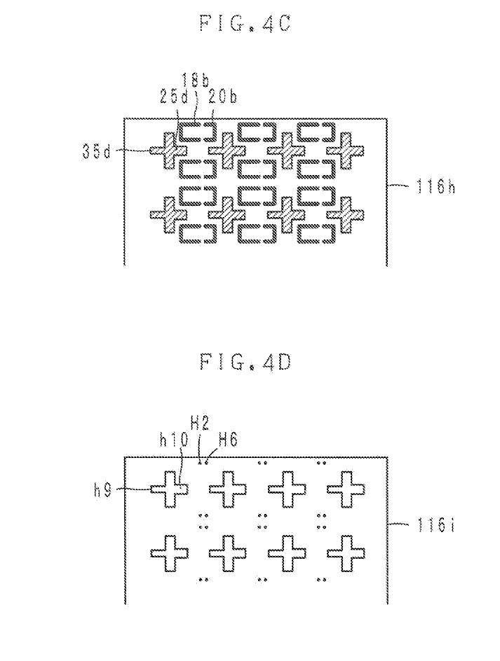

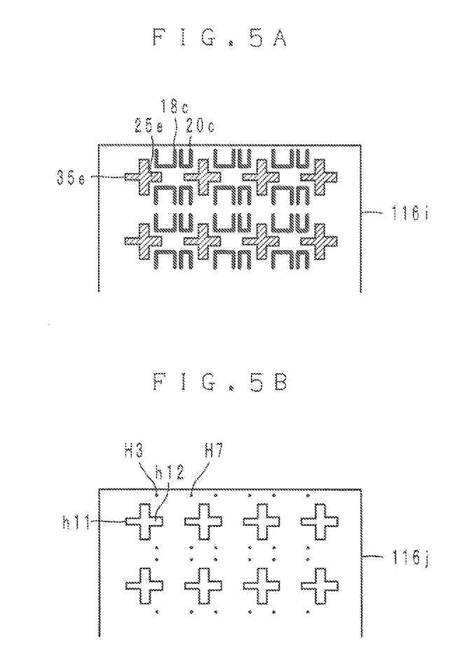

Then, as shown in FIG. 4A, the coil conductor layers 18a, 20a and external conductor layers 25c, 35c are simultaneously formed by photolithography. Specifically, a photosensitive electrically-conductive paste whose metal main component is Ag is applied by screen printing to form an electrically-conductive paste layer on the insulating paste layer 116g. Further, the electrically-conductive paste layer is irradiated with ultraviolet light or the like via a photomask and is developed using an alkaline solution or the like. Thereby, the external conductor layers 35c, 25c are formed in the openings h5, h6, and the coil conductor layers 18a, 20a are formed on the insulating paste layer 116g.

Then, as shown in FIG. 4B, an insulating paste layer 116h which has openings h7, h8 and via holes H1, H5 is formed by photolithography. Specifically, a photosensitive insulating paste is applied by screen printing to form an insulating paste layer 116h on the insulating paste layer 116g. Further, the insulating paste layer is irradiated with ultraviolet light or the like via a photomask and is developed using an alkaline solution or the like. The insulating paste layer 116h is a paste layer which is to be the insulator layer 16h. Each of the openings h7, h8 has a T-shape which is realized by joining two external conductor layers 35d, 25d. The openings h7, h8 are joined together to have a cruciform shape.

Then, as shown in FIG. 4C, coil conductor layers 18b, 20b, external conductor layers 25d, 35d, and via hole conductors v1, v5 are simultaneously formed by photolithography. Specifically, a photosensitive electrically-conductive paste whose metal main component is Ag is applied by screen printing to form an electrically-conductive paste layer on the insulating paste layer 116h. Further, the electrically-conductive paste layer is irradiated with ultraviolet light or the like via a photomask and is developed using an alkaline solution or the like. Thereby, the external conductor layers 35d, 25d are formed in the openings h5, h6, the coil conductor layers 18b, 20b are formed on the insulating paste layer 116h, and the via hole conductors v1, v5 are formed in the via holes H1, H5.

Then, as shown in FIG. 4D, an insulating paste layer 116i which has openings h9, h10 and via holes H2, H6 is formed by photolithography. Specifically, a photosensitive insulating paste is applied by screen printing to form an insulating paste layer 116i on the insulating paste layer 116h. Further, the insulating paste layer is irradiated with ultraviolet light or the like via a photomask and is developed using an alkaline solution or the like. The insulating paste layer 116i is a paste layer which is to be the insulator layer 16i. Each of the openings h9, h10 has a T-shape which is realized by joining two external conductor layers 35e, 25e. The openings h9, h10 are joined together to have a cruciform shape.

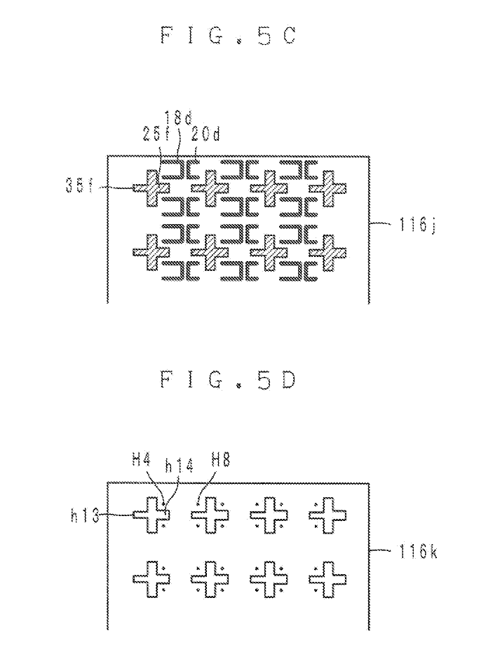

Then, as shown in FIG. 5A, coil conductor layers 18c, 20c, external conductor layers 25e, 35e, and via hole conductors v2, v6 are simultaneously formed by photolithography. Specifically, a photosensitive electrically-conductive paste whose metal main component is Ag is applied by screen printing to form an electrically-conductive paste layer on the insulating paste layer 116i. Further, the electrically-conductive paste layer is irradiated with ultraviolet light or the like via a photomask and is developed using an alkaline solution or the like. Thereby, the external conductor layers 35e, 25e are formed in the openings h9, h10, the coil conductor layers 18c, 20c are formed on the insulating paste layer 116i, and the via hole conductors v2, v6 are formed in the via holes H2, H6.

Then, as shown in FIG. 5B, an insulating paste layer 116j which has openings h11, h12 and via holes H3, H7 is formed by photolithography. Specifically, a photosensitive insulating paste is applied by screen printing to form an insulating paste layer 116j on the insulating paste layer 116i. Further, the insulating paste layer is irradiated with ultraviolet light or the like via a photomask and is developed using an alkaline solution or the like. The insulating paste layer 116j is a paste layer which is to be the insulator layer 16j. Each of the openings h11, h12 has a T-shape which is realized by joining two external conductor layers 35f, 25f. The openings h11, h12 are joined together to have a cruciform shape.

Then, as shown in FIG. 5C, coil conductor layers 18d, 20d, external conductor layers 25f, 35f, and via hole conductors v3, v7 are simultaneously formed by photolithography. Specifically, a photosensitive electrically-conductive paste whose metal main component is Ag is applied by screen printing to form an electrically-conductive paste layer on the insulating paste layer 116j. Further, the electrically-conductive paste layer is irradiated with ultraviolet light or the like via a photomask and is developed using an alkaline solution or the like. Thereby, the external conductor layers 35f, 25f are formed in the openings h11, h12, the coil conductor layers 18d, 20d are formed on the insulating paste layer 116j, and the via hole conductors v3, v7 are formed in the via holes H3, H7.

Then, as shown in FIG. 5D, an insulating paste layer 116k which has openings h13, h14 and via holes H4, H8 is formed by photolithography. Specifically, a photosensitive insulating paste is applied by screen printing to form an insulating paste layer 116k on the insulating paste layer 116j. Further, the insulating paste layer is irradiated with ultraviolet light or the like via a photomask and is developed using an alkaline solution or the like. The insulating paste layer 116k is a paste layer which is to be the insulator layer 16k. Each of the openings h13, h14 has a T-shape which is realized by joining two external conductor layers 35g, 25g. The openings h13, h14 are joined together to have a cruciform shape.

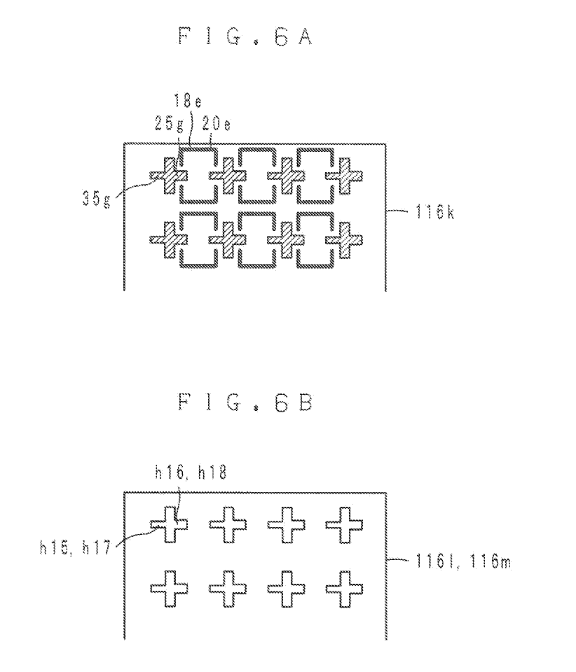

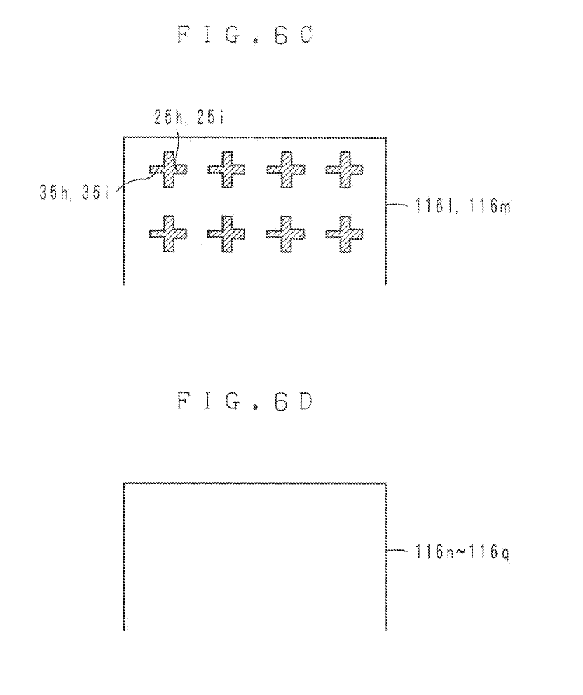

Then, as shown in FIG. 6A, coil conductor layers 18e, 20e, external conductor layers 25g, 35g, and via hole conductors v4, v8 are simultaneously formed by photolithography. Specifically, a photosensitive electrically-conductive paste whose metal main component is Ag is applied by screen printing to form an electrically-conductive paste layer on the insulating paste layer 116k. Further, the electrically-conductive paste layer is irradiated with ultraviolet light or the like via a photomask and is developed using an alkaline solution or the like. Thereby, the external conductor layers 35g, 25g are formed in the openings h13, h14, the coil conductor layers 18e, 20e are formed on the insulating paste layer 116k, and the via hole conductors v4, v8 are formed in the via holes H4, H8.

Then, as shown in FIG. 6B, an insulating paste layer 116l which has openings h15, h16 is formed by photolithography. Specifically, a photosensitive insulating paste is applied by screen printing to form an insulating paste layer 116l on the insulating paste layer 116k. Further, the insulating paste layer is irradiated with ultraviolet light or the like via a photomask and is developed using an alkaline solution or the like. The insulating paste layer 116l is a paste layer which is to be the insulator layer 16l. Each of the openings h15, h16 has a T- shape which is realized by joining two external conductor layers 35h, 25h. The openings h15, h16 are joined together to have a cruciform shape.

Then, as shown in FIG. 6C, external conductor layers 25h, 35h are formed by photolithography. Specifically, a photosensitive electrically-conductive paste whose metal main component is Ag is applied by screen printing to form an electrically-conductive paste layer on the insulating paste layer 116l. Further, the electrically-conductive paste layer is irradiated with ultraviolet light or the like via a photomask and is developed using an alkaline solution or the like. Thereby, the external conductor layers 35h, 25h are formed in the openings h15, h16.

Then, as shown in FIG. 6B, an insulating paste layer 116m which has openings h17, h18 is formed by photolithography. Specifically, a photosensitive insulating paste is applied by screen printing to form an insulating paste layer 116m on the insulating paste layer 116l. Further, the insulating paste layer is irradiated with ultraviolet light or the like via a photomask and is developed using an alkaline solution or the like. The insulating paste layer 116m is a paste layer which is to be the insulator layer 16m. Each of the openings h17, h18 has a T-shape which is realized by joining two external conductor layers 35i, 25i. The openings h17, h18 are joined together to have a cruciform shape.

Then, as shown in FIG. 6C, external conductor layers 25i, 35i are formed by photolithography. Specifically, a photosensitive electrically-conductive paste whose metal main component is Ag is applied by screen printing to form an electrically-conductive paste layer on the insulating paste layer 116m. Further, the electrically-conductive paste layer is irradiated with ultraviolet light or the like via a photomask and is developed using an alkaline solution or the like. Thereby, the external conductor layers 35i, 25i are formed in the openings h17, h18.

Then, as shown in FIG. 6D, an insulating paste is repeatedly applied by screen printing to form insulating paste layers 116n to 116q. The insulating paste layers 116n to 116q are paste layers which are to be the insulator layers 16n to 16q that are insulator layers for outer layers, which are arranged at outer positions from the coils L. Throughout the above-described process, a mother multilayer body 112 is obtained.

Then, the mother multilayer body 112 is cut into a plurality of un sintered multilayer bodies 12 by dicing or the like. In the step of cutting the mother multilayer body 112, the external electrodes 14a, 14b are exposed from the multilayer body 12 at cut surfaces which are formed by cutting.

Then, the unsintered multilayer bodies 12 are sintered under predetermined conditions, whereby the multilayer bodies 12 are obtained. Further, the multilayer bodies 12 are subjected to barrel processing.

Lastly, a Ni plating layer which has a thickness of 2 μm to 7 μm and a Sn plating layer which has a thickness of 2 μm to 7 μm are formed over portions in which the external electrodes 14a, 14b are exposed from the multilayer body 12. Throughout the above-described process, the electronic component 10 is completed.

### Effects

According to the electronic component 10 which has the above-described configuration, the positional relationship between the external electrodes 14a, 14b and the coils L1, L2 is unlikely to deviate from a predetermined positional relationship. More specifically, in the case of an electronic component in which an external electrode is formed in a surface of a multilayer body after formation of the multilayer body that includes a coil, the positional relationship between the external electrode and the coil is likely to deviate from a predetermined positional relationship due to, for example, a variation in the cut position of the multilayer body or a variation in formation of the external electrode.

On the other hand, in the case of the electronic component 10, the external conductor layers 25c to 25g and 35c to 35g, which are provided on the same insulator layers 16g to 16k on which the coil conductor layers 18a to 18e and 20a to 20e are provided, are formed by photolithography simultaneously with formation of the coil conductor layers 18a to 18e and 20a to 20e. Therefore, the position accuracy of the coil conductor layers 18a to 18e and 20a to 20e and the external conductor layers 25c to 25g and 35c to 35g depends on the accuracy of photolithography. Thus, in the case of the electronic component 10, the positional relationship between the external electrodes 14a, 14b and the coils L1, L2 is unlikely to deviate from a predetermined positional relationship as compared with an electronic component in which an external electrode is formed in a surface of a multilayer body after formation of the multilayer body that includes a coil.

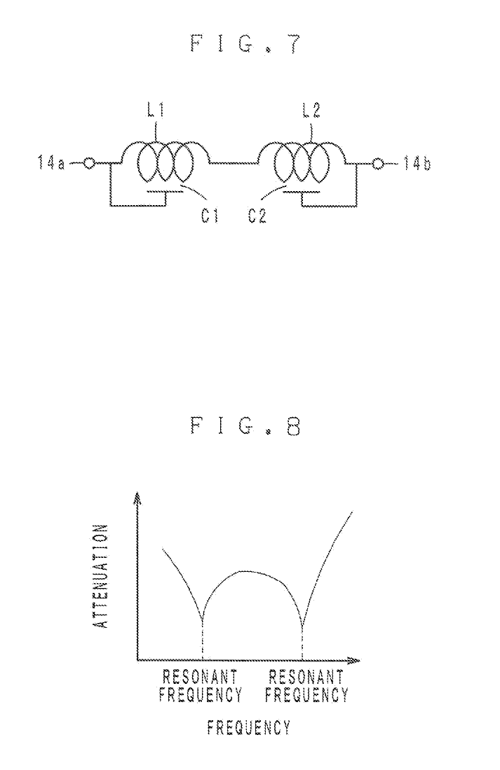

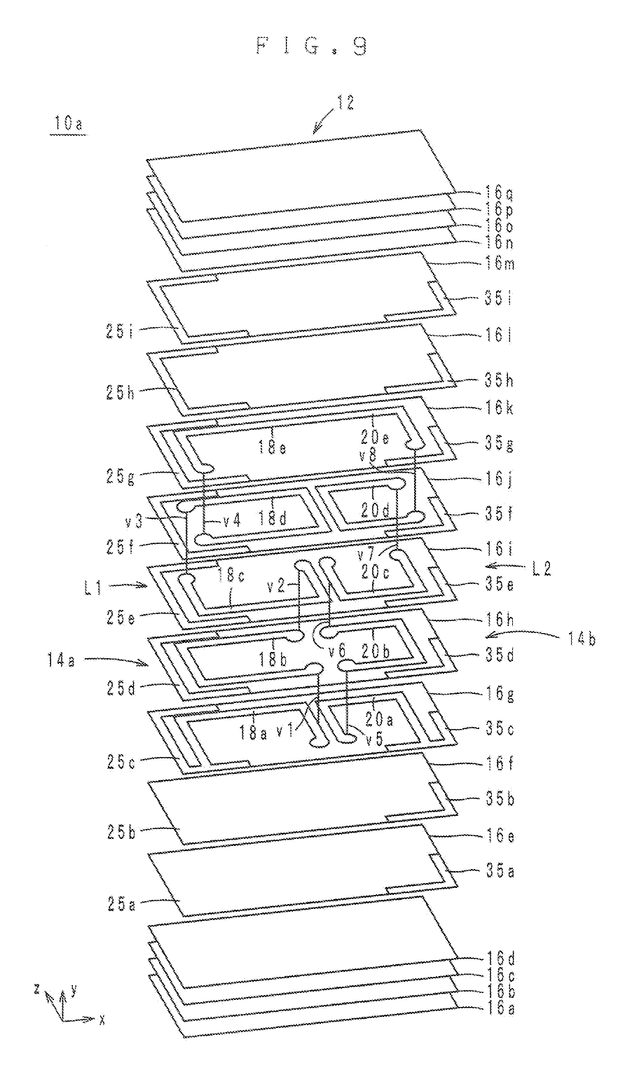

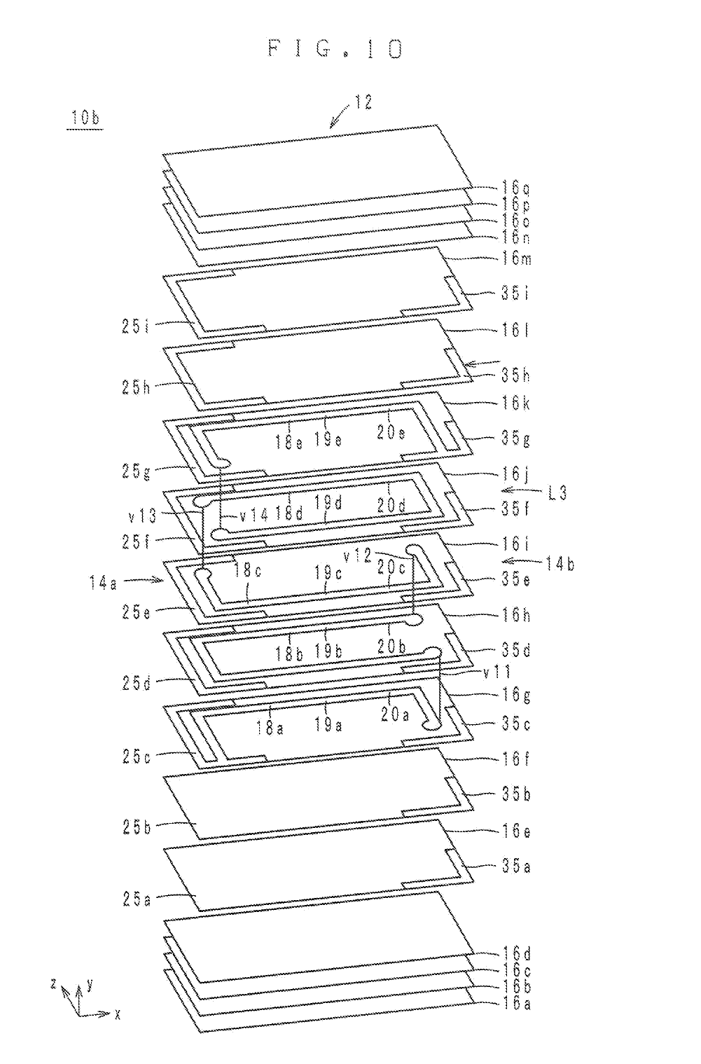

Further, the electronic component 10 can readily have a structure which can be configured to have arbitrary electric characteristics. FIG. 7 is an equivalent circuit diagram of the electronic component 10. FIG. 8 is a graph showing the relationship between the frequency and the attenuation of the output signal relative to the input signal in the electronic component 10. The horizontal axis represents the frequency, and the vertical axis represents the attenuation.

In the electronic component 10, the coils L1, L2 are connected in series between the external electrodes 14a, 14b as shown in FIG. 7. The external electrodes 14a, 14b face on the coils L1, L2, respectively, so that capacitors C1, C2 are respectively formed between the external electrodes 14a, 14b and the coils L1, L2. With this configuration, the electronic component 10 forms a noise filter which has two resonant frequencies shown in FIG. 8.

Here, in the electronic component 10, the external electrode 14a and the external electrode 14b have different shapes. Therefore, the shape of each of the external electrodes 14a, 14b can be independently designed, and the capacitors C1, C2 can be formed so as to have arbitrary capacitance values. As a result, the two resonant frequencies shown in FIG. 8 can be changed. In view of the foregoing, the electronic component 10 can have a structure which can be configured to have arbitrary electric characteristics.

### First Variation

Next, an electronic component 10a according to the first variation is described with reference to the drawings. FIG. 9 is an exploded perspective view of the electronic component 10a according to the first variation.

The difference between the electronic component 10a and the electronic component 10 resides in the shape of the external electrode 14a. Specifically, in the electronic component 10, the external electrode 14a and the external electrode 14b are equal in terms of the shape of a portion of the external electrode 14a which is exposed from the multilayer body 12 and the shape of a portion of the external electrode 14b which is exposed from the multilayer body 12. However, they have different thicknesses in these portions so that they have different shapes.

On the other hand, in the electronic component 10a, the shape of a portion of the external electrode 14a which is exposed from the multilayer body 12 and the shape of a portion of the external electrode 14b which is exposed from the multilayer body 12 are different so that the external electrodes 14a, 14b have different shapes. The external electrode 14a extends over the lateral surfaces 51, S3, S2 and has an inverted C shape when viewed in plan from the y-axis direction. On the other hand, the external electrode 14b extends over the lateral surfaces S2, S4 and has an L shape. In the present embodiment, the thickness of the external electrode 14a and the thickness of the external electrode 14b are equal. Note that, however, the thickness of the external electrode 14a and the thickness of the external electrode 14b may be different.

In the electronic component 10a which has the above-described configuration, the external electrode 14a is provided in the lateral surface 51. The lateral surface S1 is a surface which is on the upper side when the electronic component 10a is mounted. Therefore, a portion of the external electrode 14a which is provided in the lateral surface S1 can be used as a direction indicator mark. Thus, in the electronic component 10a, it is not necessary to form an additional direction indicator mark.

In the electronic component 10a, the area of a portion of the external electrode 14a which faces on the coil L1 and the area of a portion of the external electrode 14b which faces on the coil L2 can be arbitrarily set. Due to this feature, the electronic component 10a can have a structure which can be configured to have arbitrary electric characteristics.

### Second Variation

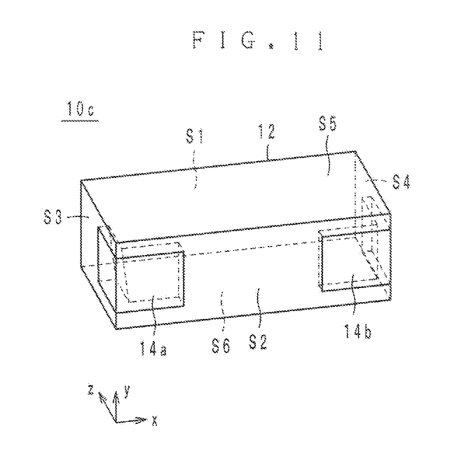

Next, an electronic component 10b according to the second variation is described with reference to the drawings. FIG. 10 is an exploded perspective view of the electronic component 10b according to the second variation.

The difference between the electronic component 10b and the electronic component 10 resides in the number of coils. Specifically, the electronic component 10 includes the coils L1, L2. On the other hand, the electronic component 10a only includes a coil L3. Thus, the number of coils is not limited to two.

### Third Variation

Next, an electronic component 10c according to the third variation is described with reference to the drawings. FIG. 11 is a perspective view of the exterior of the electronic component 10c according to the third variation.

The difference between the electronic component 10c and the electronic component 10 resides in the shape of the external electrode 14a. More specifically, in the electronic component 10, the external electrode 14a has a certain thickness as shown in FIG. 1. On the other hand, in the electronic component 10c, the thickness of the external electrode 14a decreases toward the positive direction side of the y-axis direction. This varying thickness of the external electrode 14a enables the capacitor C1 to have a varying capacitance.

An electronic component according to the present disclosure is not limited to the electronic components 10, 10a to 10c of the above-described embodiments but can be modified within the scope of the spirit of the disclosure.

In the electronic component 10, the coil conductor layers 18, 20 are to be formed by photolithography but may be formed by printing.

What is claimed is:

1. An electronic component comprising:
a multilayer body having a shape of a rectangular parallelepiped, and including a plurality of stacked insulator layers;
a first coil including at least one first coil conductor layer provided on at least one of the plurality of the insulator layers; and
first and second external electrodes embedded in a lateral surface of the multilayer body which is formed by a series of continuous perimeter edges of the plurality of insulator layers, the first and second external electrodes including a plurality of stacked external conductor layers, the plurality of stacked external conductor layers being provided on the plurality of insulator layers,
wherein the first external electrode and the second external electrode have different shapes, and
the external conductor layers and the first coil conductor being photolithographed or printed on the same insulator layer.

2. The electronic component according to claim 1, further comprising a second coil including at least one second coil conductor layer provided on at least one of the plurality of the insulator layers, wherein the external conductor layers and the second coil conductor are photolithographed or printed on the same insulator layer.

3. The electronic component according to claim 1, wherein a thickness of the first external electrode is different from a thickness of the second external electrode.

4. The electronic component according to claim 1, wherein a shape of a portion of the first external electrode which is exposed from the multilayer body is different from a shape of a portion of the second external electrode which is exposed from the multilayer body.

5. The electronic component according to claim 1, wherein
the first external electrode extends over three lateral surfaces, and
the second external electrode extends over two lateral surfaces.
